(19) United States
(12) Patent Application Publication
(10) Pub. No.: US 2025/0128206 A1
(43) Pub. Date: Apr. 24, 2025

(54) SEAL STRUCTURE, HEAT RECOVERY STEAM GENERATOR, AND FLUE GAS SEALING METHOD

(71) Applicant: MITSUBISHI HEAVY INDUSTRIES, LTD., Tokyo (JP)

(72) Inventors: Tsuyoshi Hirai, Tokyo (JP); Tsuyoshi Yamaguchi, Kanagawa (JP)

(73) Assignee: MITSUBISHI HEAVY INDUSTRIES, LTD., Tokyo (JP)

(21) Appl. No.: 18/835,201

(22) PCT Filed: Dec. 27, 2022
(86) PCT No.: PCT/JP2022/048231

§ 371 Date: Aug. 1, 2024

(30) Foreign Application Priority Data
Feb. 4, 2022 (JP) 2022-016521

(51) Int. Cl. B01D 53/86; B01D 53/34; B01D 53/88

(52) U.S. Cl. CPC B01D 53/8631; B01D 53/343; B01D 53/885; B01D 2255/20707; B01D 2257/404; B01D 2258/0283

(57) ABSTRACT

There are provided a thermal barrier coating material and a thermal barrier coating member that can suppress spalling when used at a high temperature and have a high thermal barrier effect, a method for producing the same, a turbine member coated with a thermal barrier coating, and a gas turbine. The thermal barrier coating member comprises a heat resistant substrate, a bond coat layer formed thereon, and a ceramic layer formed further thereon, wherein the ceramic layer comprises an oxide which consists of an oxide represented by the general formula A₂Zr₂O₇ doped with a predetermined amount of CaO or MgO and has 10 volume % or more of a pyrochlore type crystal structure, where A represents any of La, Nd, Sm, Gd, and Dy.

### TECHNICAL FIELD

The present disclosure a seal structure, a heat recovery steam generator, and a flue gas sealing method.

### BACKGROUND ART

In heat recovery steam generators (HRSG), a flue gas discharged from a gas turbine or the like passes through in a duct, heat exchange between the flue gas and water or steam in heat transfer tubes is performed to generate steam. A plurality of heat exchangers having a number of heat transfer tubes through which water or steam flows, a flue gas denitrizer that removes nitrogen oxides (NOx) in the flue gas, and the like are installed inside the duct of a heat recovery steam generator.

A gap is formed between a flue gas denitrizer and a duct accommodating the flue gas denitrizer. In this gap, a short path of a flue gas (that a flue gas flows through to downstream of a flue gas denitrizer without passing through the flue gas denitrizer) may occur. Thus, to suppress occurrence of a short path of a flue gas, a seal structure may be provided to the gap (for example, Patent Literature 1).

Patent Literature 1 discloses a heat recovery steam generator in which the lower group of heat transfer tubes, a flue gas denitrizer (catalyst), and the upper group of heat transfer tubes are arranged inside a casing at predetermined intervals from below to above. Further, in this device, an elastically deformable seal member is interposed between the inner face of the casing and the flue gas denitrizer. The seal member connects a horizontal flange fixed to the entire circumference of the inner wall face of the casing to a fitting flange fixed to the entire circumference of the bottom outer circumferential part of a flame body.

### CITATION LIST

### Patent Literature

### [PTL 1]

Japanese Patent Application Laid-Open No. 2014-178103

### SUMMARY OF INVENTION

### Technical Problem

In recent years, in terms of reducing greenhouse gas emissions, power generation plants using hydrogen or ammonia as fuel have attracted attention. When hydrogen or ammonia is used as fuel, however, the amount of generation of nitrogen oxides (NOx) is expected to significantly increase compared to a case where conventional fuel such as coal is used. Thus, to reduce NOx emissions in power generation plants that use hydrogen or ammonia as fuel, it is necessary to more strictly suppress occurrence of a short path of a flue gas. From this point of view, a technology to more effectively suppress occurrence of a short path of a flue gas is desired.

Since a high-temperature flue gas passes through in the casing, the casing and the flue gas denitrizer are heated by heat of the flue gas and thermally expanded. Further, heat insulating materials are provided to the outer circumferential face or the inner circumferential face of the casing so that the heat of the flue gas is not transferred externally. When heat insulating materials are attached to the outer circumferential face of the casing (hereafter, referred to as “external thermal insulation form”), since the temperature difference and the thermal expansion difference between the casing and the flue gas denitrizer are small, the gap formed between the casing and the flue gas denitrizer is also small. In contrast, when heat insulating materials are attached to the inner circumferential face of the casing (hereafter, referred to as “internal thermal insulation form”), since the temperature difference and the thermal expansion difference between the casing and the flue gas denitrizer are larger, the gap formed between the casing and the flue gas denitrizer is also larger.

As discussed above, while a gap is formed between the casing and the flue gas denitrizer in both cases where the external thermal insulation form is applied and where the internal thermal insulation form is applied, the gap formed between the casing and the flue gas denitrizer tends to be larger in the case where the internal thermal insulation form is applied. Thus, the amount of a flue gas taking a short path tends to be larger.

Further, as with the device disclosed in Patent Literature 1, in a case of a duct of the vertical flow system in which a flue gas flows through vertically, the duct and the flue gas denitrizer thermally expand vertically from a load support point as a base point and thermally expand horizontally, evenly about the central axis of the duct. Thus, the gap formed between the casing and the flue gas denitrizer is substantially even in the entire circumference. In contrast, in a case of a duct of the horizontal flow system in which a flue gas flows through horizontally, since the duct and the flue gas denitrizer thermally expand in an expanding direction from the bottom face that is the load support point, the displacement difference between a part near the bottom face and a part near the ceiling is very different. Thus, the gap formed between the casing and the flue gas denitrizer is not substantially even in the entire circumference.

The seal structure disclosed in Patent Literature 1 is fixed to the duct and the flue gas denitrizer. Thus, when the seal structure disclosed in Patent Literature 1 is applied to the duct of the horizontal flow system, variation will occur in the amount of deformation of the seal member due to the displacement difference between a part near the bottom face and a part near the ceiling, and a part of the seal member having a large amount of deformation is likely to be deteriorated or damaged. When the seal member is deteriorated or damaged, the sealing performance is reduced at the deteriorated portion or the damaged portion, the flue gas will take a short path, and thus, the amount of the flue gas taking the short path may increase.

As discussed above, while a gap is formed between the casing and the flue gas denitrizer in both cases where the duct of the vertical flow system is used and where the duct of the horizontal flow system is used, a case where the duct of the horizontal flow system is employed tends to cause a displacement difference of the duct or the like in the entire circumference. Thus, the amount of the flue gas taking a short path tends to be larger.

As described above, while a short path may occur in all the external thermal insulation form, the internal thermal insulation form, the duct of the vertical flow system, and the duct of the horizontal flow system, a short path of a flow gas may increase particularly in the internal thermal insulation form or the horizontal flow system.

The present disclosure has been made in view of such circumstances and intends to provide a seal structure, a heat recovery steam generator, and a flue gas sealing method that can reduce the amount of an un-denitrated flue gas flowing through to downstream of a flue gas denitrizer.

In particular, the present disclosure intends to provide a seal structure, a heat recovery steam generator, and a flue gas sealing method that can effectively reduce the amount of an un-denitrated flue gas flowing through to downstream of a flue gas denitrizer in a case of the internal thermal insulation form or the horizontal flow system.

### Solution to Problem

To solve the above problem, a seal structure, a heat recovery steam generator, and a flue gas sealing method of the present disclosure employ the following solutions.

The seal structure according to one aspect of the present disclosure is a seal structure configured to seal a gap formed between a duct in which a flue gas flows through and a flue gas denitrizer arranged in the duct, the seal structure includes: at least one duct-side seal part fixed to the duct and arranged in the gap; a flue gas denitrizer-side seal part fixed to the flue gas denitrizer, arranged in the gap, and abutting against or being close to the duct-side seal part; and a first catalyst seal part fixed to the flue gas denitrizer, arranged in the gap, and configured to push the duct-side seal part against the flue gas denitrizer-side seal part, and the first catalyst seal part is formed of a denitration catalyst.

The flue gas sealing method according to one aspect of the present disclosure is a flue gas sealing method using a seal structure configured to seal a gap formed between a duct in which a flue gas flows through and a flue gas denitrizer arranged in the duct, the seal structure includes a duct-side seal part fixed to the duct and arranged in the gap, a flue gas denitrizer-side seal part fixed to the flue gas denitrizer, arranged in the gap, and abutting against or being close to the duct-side seal part, and a first catalyst seal part fixed to the flue gas denitrizer, arranged in the gap, and configured to push the duct-side seal part against the flue gas denitrizer-side seal part, the first catalyst seal part is formed of a denitration catalyst, and the flue gas sealing method includes: sealing a gap formed between the duct and the flue gas denitrizer by using the duct-side seal part, the flue gas denitrizer-side seal part, and the first catalyst seal part.

### Advantageous Effects of Invention

According to the present disclosure, the amount of an un-denitrated flue gas flowing through to downstream of a flue gas denitrizer can be reduced.

In particular, the amount of an un-denitrated flue gas flowing through to downstream of a flue gas denitrizer can be effectively reduced in a case of the internal thermal insulation form or the horizontal flow system.

### BRIEF DESCRIPTION OF DRAWINGS

FIG. 1 is a configuration diagram illustrating a heat recovery steam generator according to a first embodiment of the present disclosure.

FIG. 2 is a perspective view illustrating a NOx removal system and a seal structure according to the first embodiment of the present disclosure.

FIG. 3 is a sectional view illustrating the seal structure according to the first embodiment of the present disclosure.

FIG. 4 is a diagram illustrating a modified example for FIG. 3.

FIG. 5 is a diagram illustrating a modified example for FIG. 3.

FIG. 6 is a perspective view illustrating a flue gas denitrizer and a seal structure according to a second embodiment of the present disclosure.

FIG. 7 is a perspective view illustrating a flue gas denitrizer and a seal structure according to a third embodiment of the present disclosure.

### DESCRIPTION OF EMBODIMENTS

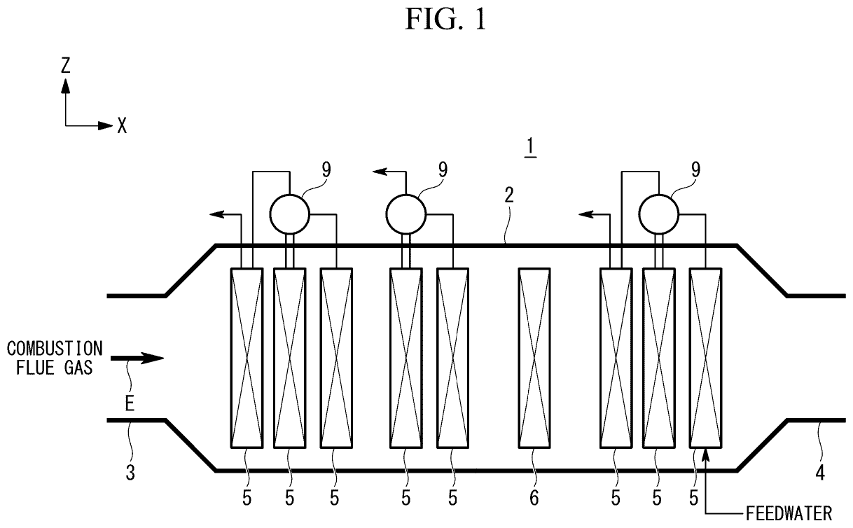

A seal structure, a heat recovery steam generator, and a flue gas sealing method according to embodiments of the present disclosure will be described below with reference to FIG. 1 to FIG. 7. In the following description and the drawings, the vertical direction is referred to as the Z-axis direction, a direction of the horizontal directions through which a flue gas flows is referred to as the X-axis direction, and the direction orthogonal to the X-axis direction and the Z-axis direction is referred to as the Y-axis direction. Further, the flowing direction of the flue gas is indicated by arrow E in FIG. 1 to FIG. 7.

### First Embodiment

A first embodiment of the present disclosure will be described below with reference to FIG. 1 to FIG. 5.

First, a heat recovery steam generator according to the present embodiment will be described with reference to FIG. 1.

As illustrated in FIG. 1, a heat recovery steam generator 1 according to the present embodiment is a horizontal type heat recovery steam generator in which a flue gas flows in the horizontal direction. In the present embodiment, a flue gas flow direction is the horizontal direction, the direction orthogonal thereto is the vertical direction, and the longitudinal direction of a heat transfer tube is the vertical direction.

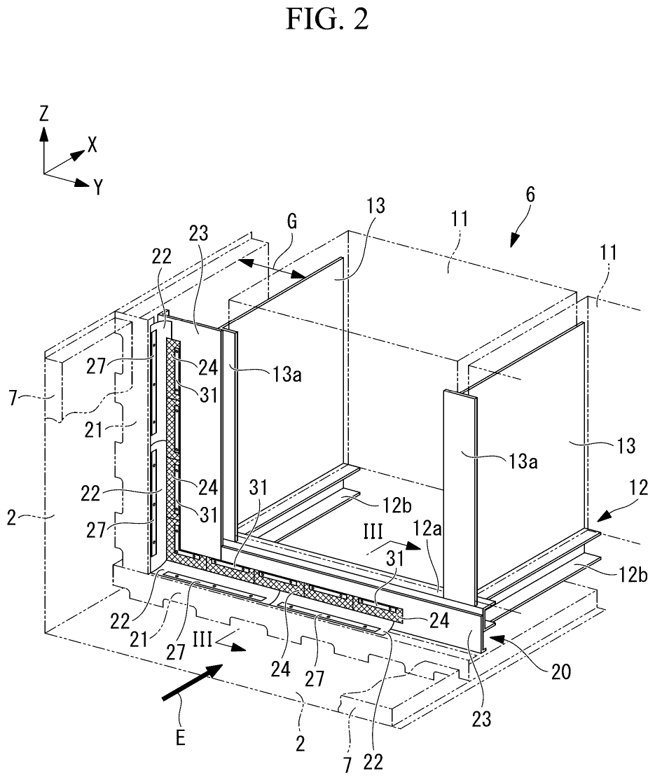

As illustrated in FIG. 1, the heat recovery steam generator 1 according to the present embodiment has heat exchange units 5 such as an economizer, an evaporator, a superheater, or the like, a flue gas denitrizer 6, and the like inside a duct 2 installed and expanding in the horizontal direction. A combustion flue gas (flue gas) at a high temperature discharged from a gas turbine or the like is introduced into the duct 2 from a duct inlet 3, passes through the plurality of heat exchange units 5 sequentially, and is then discharged from a stack (not illustrated) via a duct outlet 4. As illustrated in FIG. 2, the duct 2 has heat insulating materials 7 provided in substantially the entire region of the inner circumferential face.

As illustrated in FIG. 1, the heat exchange units 5 each have a plurality of heat transfer tubes (not illustrated) installed and extending in the vertical direction so as to intersect the flue gas flow direction. Further, headers (not illustrated) that connect a plurality of heat transfer tubes to each other are provided inside the duct 2, and a drum 9 is provided outside the duct 2. Each of the headers is connected to the drum 9 via a communication tube (not illustrated).

The heat exchange units 5 recover heat of a flue gas by heat exchange between a thermal medium (for example, water or steam) flowing through inside the heat transfer tubes and the flue gas. The thermal medium heated by the heat of the flue gas is guided to the drum 9 via the header and the communication tube.

Next, details of the flue gas denitrizer 6 and a seal structure 20 according to the present embodiment will be described with reference to FIG. 2 to FIG. 5. Note that, in the following description, when “center side” and “outside” are simply referred, the “center side” and the “outside” based on the central axis of the duct 2 are meant.

As illustrated in FIG. 2, the flue gas denitrizer 6 according to the present embodiment has a plurality of catalyst packs 11 that remove nitrogen oxides contained in a flue gas (denitrate the flue gas), a support frame 12 supporting each catalyst pack 11 from below, a plurality of leg parts (not illustrated) erected on the bottom face of the duct 2 and supporting the support frame 12 from below, and walls 13 covering the side faces in the Y-axis direction of the catalyst packs 11.

The plurality of catalyst packs 11 are aligned so as to cover substantially the entire region of the flow channel cross section (the cross section defined by the Z-axis direction and the Y-axis direction) of the duct 2. Note that, in the present embodiment, a plurality of catalyst packs 11 are provided in the Z-axis direction, and a plurality of catalyst packs 11 are provided in the Y-axis direction. Each catalyst pack 11 is placed on the top face of the support frame 12.

For example, each catalyst pack 11 has a rectangular-cylindrical rectangular frame part (not illustrated) and a plurality of catalysts (not illustrated) provided inside the rectangular frame part. An example of the shape of the catalyst is, but is not limited thereto, a honeycomb shape or a corrugated plate shape. The catalyst promotes a reduction reaction of NOx (nitrogen oxides) contained in a flue gas (combustion gas) passing through the inside thereof and removes at least a part of NOx. For example, the component of the catalyst is based on titanium oxide.

The support frame 12 has first support beams 12a extending in the Y-axis direction and second support beams 12b extending in the X-axis direction. The first support beams 12a and the second support beams 12b each are a long member, so-called die steel, whose cross section when cut along a plane orthogonal to the extending direction has a shape such as a substantially H-shape, a substantially C-shape, or the like. The plurality of first support beams 12a are aligned at predetermined intervals along the X-axis direction. The plurality of second support beams 12b are aligned at predetermined intervals along the Y-axis direction. The support frame 12 provided on the bottom row is supported from below by leg parts.

The walls 13 are erected on the top face of the support frame 12. The end in the X-axis direction of each wall 13 is provided with a flange part 13a extending in the Y-axis direction. The wall 13 is provided between the catalyst packs 11 arranged adjacent to each other in the Y-axis direction. Further, the wall 13 arranged at the most end in the Y-axis direction is provided between the catalyst pack 11 and the inner circumferential face of the duct 2 so as to face the inner circumferential face of the duct 2. A gap G is formed between the wall 13 arranged at the most end in the Y-axis direction and the inner circumferential face of the duct 2.

Further, gaps G are also formed between the bottom face of the catalyst pack 11 arranged on the bottom row and the inner circumferential face of the duct 2 and between the top face of the catalyst pack 11 arranged on the top row and the inner circumferential face of the duct 2.

The gap G formed between the wall 13 arranged at the most end in the Y-axis direction and the inner circumferential face of the duct 2 is provided with the seal structure 20 that seals the gap G so that no flue gas flows thereinto. Further, the seal structure 20 that seals the gap G so that no flue gas flows thereinto is also provided in the gap G formed between the bottom face of the catalyst pack 11 arranged on the bottom row and the inner circumferential face of the duct 2 and between the top face of the catalyst pack 11 arranged on the top row and the inner circumferential face of the duct 2. The seal structure 20 suppresses occurrence of a short path of the flue gas (that the flue gas flows through to downstream of the flue gas denitrizer 6 without passing through the flue gas denitrizer 6) by sealing the gap G.

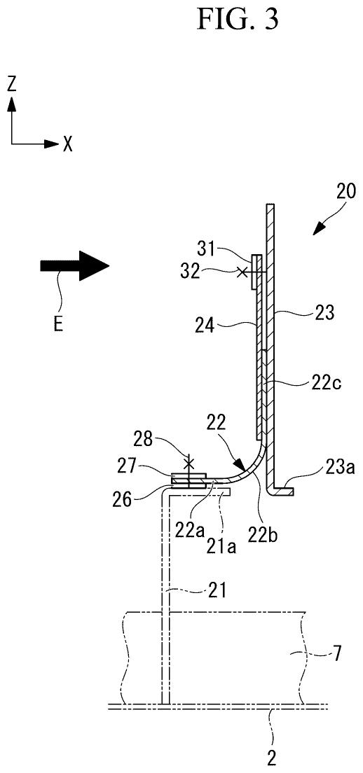

As illustrated in FIG. 2 and FIG. 3, the seal structure 20 includes seal mounting bars 21 fixed to the inner circumferential face of the duct 2 and protruding from the inner circumferential face to the center side; and a plurality of sealing devices (duct-side seal parts) 22 fixed to the center-side end of the seal mounting bars 21. Further, the seal structure 20 includes: seal plates (flue gas denitrizer-side seal parts) 23 fixed to the walls 13 or/and the support frame 12 and protruding outward from the walls 13 or/and the support frame 12; and a plurality of first plate type catalysts (first catalyst seal parts) 24 fixed to the upstream face of the seal plates 23.

Each seal mounting bar 21 is a plate-like member and is fixed to substantially the entire circumference of the inner circumferential face of the duct 2. Each seal mounting bar 21 protrudes from the inner circumferential face of the duct 2. The outer end of the seal mounting bar 21 is embedded in the heat insulating material 7. The center-side end of the seal mounting bar 21 is arranged at a position of the gap G when viewed from the duct inlet 3 side. The center-side end of the seal mounting bar 21 is provided with a flange part 21a bent and extending in the downstream direction. The sealing devices 22 are fixed to the center-side face of the flange part 21a.

Each sealing device 22 is a plate-like member and is fixed to the duct 2. In detail, the sealing device 22 is fixed to the duct 2 via the seal mounting bar 21. The sealing device 22 is a long member extending in the Z-axis direction or the Y-axis direction. The sealing device 22 is provided at a position of the gap G when viewed from the duct inlet 3 side.

A plurality of sealing devices 22 extending in the Y-axis direction are aligned along the Y-axis direction. Further, a plurality of sealing devices 22 extending in the Z-axis direction are aligned along the Z-axis direction. The sealing devices 22 adjacent to each other are arranged so that the ends thereof in the longitudinal direction overlap with each other.

As illustrated in FIG. 3, the sealing device 22 has, in an integrated manner, a fixing part 22a in surface contact with the seal mounting bar 21 via a gasket 26, a curved part 22b curved at substantially a right angle from the downstream end to the center side of the fixing part 22a, and an abutment part 22c extending from the center-side end to the center side of the curved part 22b. The sealing device 22 pushes itself against the seal plate 23. That is, the sealing device 22 pushes the seal plate 23 by elastic force toward downstream. Further, the sealing device 22 is not fixed to the seal plate 23 and the first plate type catalyst 24. That is, the sealing device 22 is arranged so as to be movable relative to the seal plate 23 and the first plate type catalyst 24.

As illustrated in FIG. 2 and FIG. 3, the fixing part 22a is provided to the outer end of the sealing device 22. The fixing part 22a is pressed by a pressing metal fitting 27 from the center side. The fixing part 22a is fixed to the flange part 21a of the seal mounting bar 21 by a plurality of fasteners 28. In detail, the fixing part 22a is fixed to the flange part 21a by the fasteners 28 penetrating through the pressing metal fitting 27, the fixing part 22a, and the gasket 26. Note that, in FIG. 2, depiction of the fasteners 28 is omitted for purposes of illustration.

The abutment part 22c is provided to the center-side end of the sealing device 22. The abutment part 22c is arranged between the seal plate 23 and the first plate type catalyst 24. In detail, the upstream face of the abutment part 22c is in surface contact with the downstream face of the first plate type catalyst 24. Further, the downstream face of the abutment part 22c is in surface contact with the upstream face of the seal plate 23.

As illustrated in FIG. 2 and FIG. 3, the seal plate 23 is a plate-like member. The center-side end of the seal plate 23 is fixed to the upstream face of the flange part 13a of the wall 13, the upstream face of the second support beam 12b, and the like. The seal plate 23 protrudes outward from the upstream face of the flange part 13a of the wall 13, the upstream face of the second support beam 12b, and the like. The seal plate 23 is arranged downstream of the sealing device 22. The seal plate 23 is provided over substantially the entire region in the circumferential direction of the flue gas denitrizer 6. The outer end of the seal plate 23 is located outside of the fixing part 22a of the sealing device 22 in the gap G when viewed from the duct inlet 3 side. The flange part 23a bent and extending to downstream is provided to the outer end of the seal plate 23. The outer face of the flange part 23a faces the inner circumferential face of the heat insulating material 7.

The first plate type catalyst 24 is a flat plate-like member. The first plate type catalyst 24 is fixed to the flue gas denitrizer 6. In detail, the first plate type catalyst 24 is fixed to the flue gas denitrizer 6 via the seal plate 23. The first plate type catalyst 24 is a long member extending in the Z-axis direction or the Y-axis direction. The outer end of the first plate type catalyst 24 is provided at a position of the gap G when viewed from the duct inlet 3 side.

The plurality of first plate type catalysts 24 extending in the Y-axis direction are aligned along the Y-axis direction. Further, the plurality of first plate type catalysts 24 extending in the Z-axis direction are aligned along the Z-axis direction.

The center-side end of the first plate type catalyst 24 is fixed to the seal plate 23. The outer end of the first plate type catalyst 24 abuts against the abutment part 22c of the sealing device 22. The first plate type catalyst 24 is arranged so as to face the seal plate 23. The first plate type catalyst 24 interposes the abutment part 22c of the sealing device 22 between the seal plate 23 and the first plate type catalyst 24.

As illustrated in FIG. 2 and FIG. 3, the center-side end of the first plate type catalyst 24 is pressed from upstream by a pressing metal fitting 31. The center-side end of the first plate type catalyst 24 is fixed to the upstream face of the seal plate 23 by a plurality of fasteners 32. In detail, the center-side end of the first plate type catalyst 24 is fixed to the seal plate 23 by the fasteners 32 penetrating through the pressing metal fitting 31 and the first plate type catalyst 24. The outer end of the first plate type catalyst 24 is not fixed to any member. Cramping the fasteners 32 causes the free end (the outer end) of the first plate type catalyst 24 to push the sealing device 22 against the seal plate 23 by elastic force. Note that, in FIG. 2, depiction of the fasteners 32 is omitted for purposes of illustration.

The first plate type catalyst 24 is provided upstream of the sealing device 22 and the seal plate 23. The first plate type catalyst 24 covers the gap between the sealing device 22 and the seal plate 23 from upstream.

The first plate type catalyst 24 is formed of a denitration catalyst. In detail, the first plate type catalyst 24 is a plate-like metal member (for example, stainless steel) carrying denitration catalyst components. The first plate type catalyst 24 is elastically deformable as with a flat spring. For example, the denitration catalyst component is based on titanium oxide.

Further, the denitration catalyst components are exposed on the surface of the first plate type catalyst 24. Thus, the first plate type catalyst 24 can denitrate a flue gas in contact therewith.

According to the present embodiment, the following effects and advantages are achieved.

Since a high-temperature flue gas flows through in the duct 2, the duct 2 and the flue gas denitrizer 6 are thermally expanded due to heat of the flue gas. In the present embodiment, since the heat insulating material 7 is provided to the inner wall face of the duct 2, a temperature difference may occur between the duct 2 and the flue gas denitrizer 6, and a thermal expansion difference may occur therebetween.

In the present embodiment, the seal member (the seal mounting bar 21 and the sealing device 22) fixed to the duct 2 and the seal member (the seal plate 23 and the first plate type catalyst 24) fixed to the flue gas denitrizer 6 are not fixed to each other. That is, the seal member fixed to the duct 2 and the seal member fixed to the flue gas denitrizer 6 seal the gap G while being movable relative to each other. Thus, even when a thermal expansion difference occurs between the duct 2 and the flue gas denitrizer 6, the seal member (the seal mounting bar 21 and the sealing device 22) fixed to the duct 2 and the seal member (the seal plate 23 and the first plate type catalyst 24) fixed to the flue gas denitrizer 6 relatively move (slide and move), and this can absorb the thermal expansion difference therebetween.

Further, in the present embodiment, the first plate type catalyst 24 is arranged in the gap G formed between the duct 2 and the flue gas denitrizer 6. Thus, the flue gas taking a short path (that the flue gas flows through to downstream of the flue gas denitrizer 6 without passing through the flue gas denitrizer 6) via the gap G formed between the duct 2 and the flue gas denitrizer 6 is denitrated by being in contact with the first plate type catalyst 24. In such a way, since the flue gas taking a short path via the gap G formed between the duct 2 and the flue gas denitrizer 6 can be denitrated, the amount of an un-denitrated flue gas flowing through to downstream of the flue gas denitrizer 6 can be reduced.

In particular, in the present embodiment, since the first plate type catalyst 24 covers the gap between the sealing device 22 and the seal plate 23 from upstream, the flue gas taking a short path via the gap between the sealing device 22 and the seal plate 23 can be denitrated.

Further, in the present embodiment, the first plate type catalyst 24 pushes the sealing device 22 against the seal plate 23. Thus, the gap formed between the sealing device 22 and the seal plate 23 can be made small. Otherwise, formation of a gap between the sealing device 22 and the seal plate 23 can be made difficult. Therefore, the amount of a flue gas taking a short path via the gap formed between the sealing device 22 and the seal plate 23 can be reduced. Thus, the amount of an un-denitrated flue gas flowing through to downstream of the flue gas denitrizer 6 can be reduced.

In the present embodiment, the first plate type catalyst 24 is a plate-like metal member. Accordingly, the first plate type catalyst 24 is elastically deformed with relatively large stress. Therefore, the first plate type catalyst 24 can strongly push the sealing device 22 against the seal plate 23. Thus, since the gap formed between the sealing device 22 and the seal plate 23 can be made smaller, the amount of a flue gas taking a short path can be further reduced.

### Modified Example 1

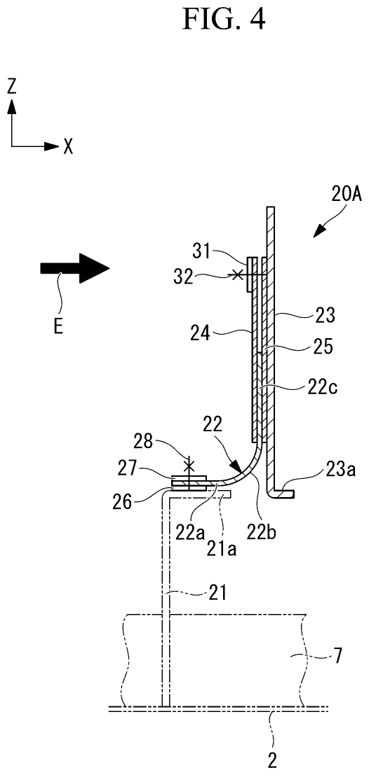

Next, a modified example for the present embodiment will be described with reference to FIG. 4. The present modified example differs from the above first embodiment in that a second plate type catalyst 25 is provided between the sealing device 22 and the seal plate 23. In other respects, since the present modified example is substantially the same as the above first embodiment, the same features are labeled with the same references, and the detailed description thereof will be omitted.

As illustrated in FIG. 4, a seal structure 20A according to the present modified example is provided with the second plate type catalyst (second catalyst seal part) 25 between the sealing device 22 and the seal plate 23.

The second plate type catalyst 25 is a flat plate-like member. The second plate type catalyst 25 is fixed to the flue gas denitrizer 6. In detail, the second plate type catalyst 25 is fixed to the flue gas denitrizer 6 via the seal plate 23. The second plate type catalyst 25 is a long member extending in the Z-axis direction or the Y-axis direction. The outer end of the second plate type catalyst 25 is provided at a position of the gap G when viewed from the duct inlet 3 side.

The plurality of second plate type catalysts 25 extending in the Y-axis direction are aligned along the Y-axis direction. Further, the plurality of second plate type catalysts 25 extending in the Z-axis direction are aligned along the Z-axis direction.

The second plate type catalyst 25 is formed of a denitration catalyst in the same manner as the first plate type catalyst 24. Since the structure of the second plate type catalyst 25 is the same as that of the first plate type catalyst 24, the detailed description thereof will be omitted.

The center-side end of the second plate type catalyst 25 is fixed to the seal plate 23. The outer end of the second plate type catalyst 25 abuts against the abutment part 22c of the sealing device 22. The upstream face of the second plate type catalyst 25 abuts against the abutment part 22c of the sealing device 22. The upstream face of the second plate type catalyst 25 is arranged so as to face the first plate type catalyst 24. The second plate type catalyst 25 interposes the abutment part 22c of the sealing device 22 between the first plate type catalyst 24 and the second plate type catalyst 25. The downstream face of the second plate type catalyst 25 is in surface contact with the upstream face of the seal plate 23.

The center-side end of the second plate type catalyst 25 is fixed to the upstream face of the seal plate 23 by a plurality of fasteners 32. In detail, the center-side end of the second plate type catalyst 25 is fixed to the seal plate 23 by the fasteners 32 penetrating through the pressing metal fitting 31, the first plate type catalyst 24, and the second plate type catalyst 25. The outer ends of the first plate type catalyst 24 and the second plate type catalyst 25 are not fixed to any member.

According to the present modified example, the following effects and advantages are achieved.

The present modified example includes the second plate type catalyst 25 arranged between the sealing device 22 and the seal plate 23. Further, the second plate type catalyst 25 is formed of a denitration catalyst. Accordingly, the flue gas taking a short path via the gap formed between the sealing device 22 and the seal plate 23 comes into contact with the second plate type catalyst 25 and is thereby denitrated. In such a way, since the flue gas taking a short path via the gap formed between the sealing device 22 and the seal plate 23 can be denitrated, the amount of an un-denitrated flue gas flowing through to downstream of the flue gas denitrizer 6 can be reduced.

Further, since the second plate type catalyst 25 is provided between the sealing device 22 and the seal plate 23, a pressure loss of a flue gas taking a short path via the gap formed between the sealing device 22 and the seal plate 23 can be increased. This makes it difficult for the flue gas to pass through the gap. Therefore, since the amount of the flue gas taking a short path via the gap can be further reduced, the amount of an un-denitrated flue gas flowing through to downstream of the flue gas denitrizer 6 can be further reduced.

### Modified Example 2

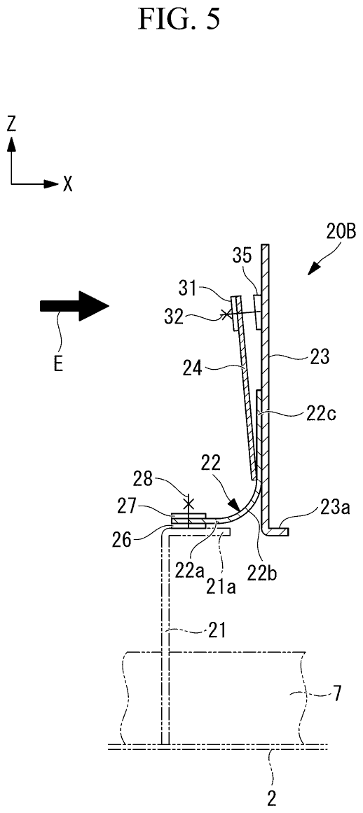

Next, a modified example for the present embodiment will be described with reference to FIG. 5. The present modified example differs from the above first embodiment in that the first plate type catalyst 24 is inclined with respect to the seal plate 23. In other respects, since the present modified example is substantially the same as the above first embodiment, the same features are labeled with the same references, and the detailed description thereof will be omitted.

As illustrated in FIG. 5, in a seal structure 20B according to the present modified example, the first plate type catalyst 24 is arranged so as to be inclined with respect to the seal plate 23. In detail, the first plate type catalyst 24 is inclined such that the distance to the sealing device 22 in the flow direction increases as the distance to the abutment part 22c (the outer end) abutting against the sealing device 22 increases. In other words, the first plate type catalyst 24 is inclined such that the outer end (unfixed end) is closer to the seal plate 23 than the center-side end (fixed end).

The seal plate 23 is provided with an engagement part 35 with which the fastener 32 engages at the top face.

According to the present modified example, the following effects and advantages are achieved.

In the present modified example, by cramping the fastener 32, it is possible to more strongly push the sealing device 22 against the seal plate 23 by the elastic force of the first plate type catalyst 24. Thus, the gap formed between the sealing device 22 and the seal plate 23 can be made smaller. Otherwise, formation of a gap between the sealing device 22 and the seal plate 23 can be made more difficult. Thus, the amount of a flue gas taking a short path can be further reduced.

### Second Embodiment

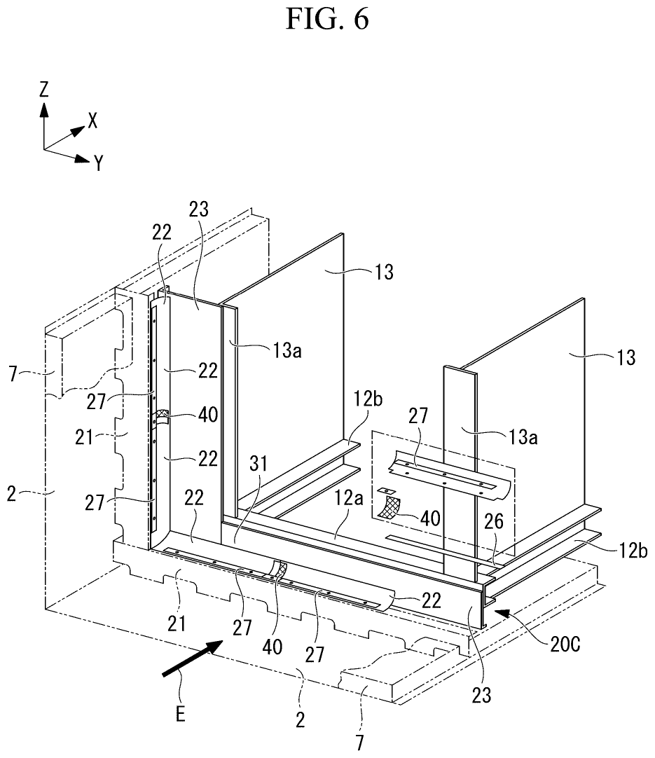

Next, a second embodiment of the present disclosure will be described with reference to FIG. 6. The present embodiment differs from the above first embodiment in that a first catalyst part (third catalyst seal part) 40 is provided in overlapping portion of the sealing devices 22 adjacent to each other. In other respects, since the present embodiment is substantially the same as the above first embodiment, the same features are labeled with the same references, and the detailed description thereof will be omitted. Note that, in FIG. 6, depiction of the first plate type catalysts 24 is omitted for purposes of illustration. Further, the portion surrounded by the one-dot chain line in FIG. 6 is an exploded view of the seal structure 20C.

As illustrated in FIG. 6, in the seal structure 20C according to the present embodiment, each first catalyst part 40 formed of a denitration catalyst is provided between the ends of the sealing devices 22 overlapping with each other. The first catalyst part 40 is arranged such that one end in the Y-axis direction is in contact with the top face of the sealing device 22 and the other end in the Y-axis direction is in contact with the bottom face of the sealing device 22.

The first catalyst part 40 is a flexible plate-like member and has a shape in accordance with the sealing device 22, in particular, has a shape in accordance with the curved part 22b of the sealing device 22.

The first catalyst part 40 is formed of a denitration catalyst. In detail, the first catalyst part 40 is cloth formed of heat-resistant fibers and carrying denitration catalyst components. An example of the heat-resistant fiber may be a ceramic fiber or a glass fiber.

According to the present embodiment, the following effects and advantages are achieved.

Since the sealing device 22 may be deformed by heat, a gap may be formed between the ends of the sealing devices 22 overlapping with each other.

In the present embodiment, the first catalyst part 40 is provided between the ends of the sealing devices 22 overlapping with each other. Thus, the flue gas taking a short path via the gap formed between the ends of the sealing devices 22 overlapping with each other is denitrated by being in contact with the first catalyst part 40. In such a way, since the flue gas taking a short path via a gap formed between the ends of the sealing devices 22 overlapping with each other can be denitrated, the amount of an un-denitrated flue gas flowing through to downstream of the flue gas denitrizer 6 can be reduced.

Further, since the first catalyst part 40 is provided between the ends of the sealing devices 22 overlapping with each other, the first catalyst part 40 can increase the pressure loss of a flue gas taking a short path via the gap formed between the ends of the sealing devices 22 overlapping with each other. This makes it difficult for the flue gas to pass through the gap. Therefore, since the amount of the flue gas taking a short path via the gap can be further reduced, the amount of an un-denitrated flue gas flowing through to downstream of the flue gas denitrizer 6 can be further reduced.

In the present embodiment, the first catalyst part 40 is cloth formed of heat-resistant fibers and carrying denitration catalyst components. Accordingly, the first catalyst part 40 is flexible compared to a case where the catalyst part is formed of a metal material, for example. Therefore, the first catalyst part 40 is deformed into a shape in accordance with a gap formed between the ends of the sealing devices 22 overlapping with each other and thus can further fill the gap. This makes it more difficult for the flue gas to pass through the gap. Therefore, since the amount of the flue gas taking a short path via the gap can be further reduced, the amount of an un-denitrated flue gas flowing through to downstream of the flue gas denitrizer 6 can be further reduced.

### Third Embodiment

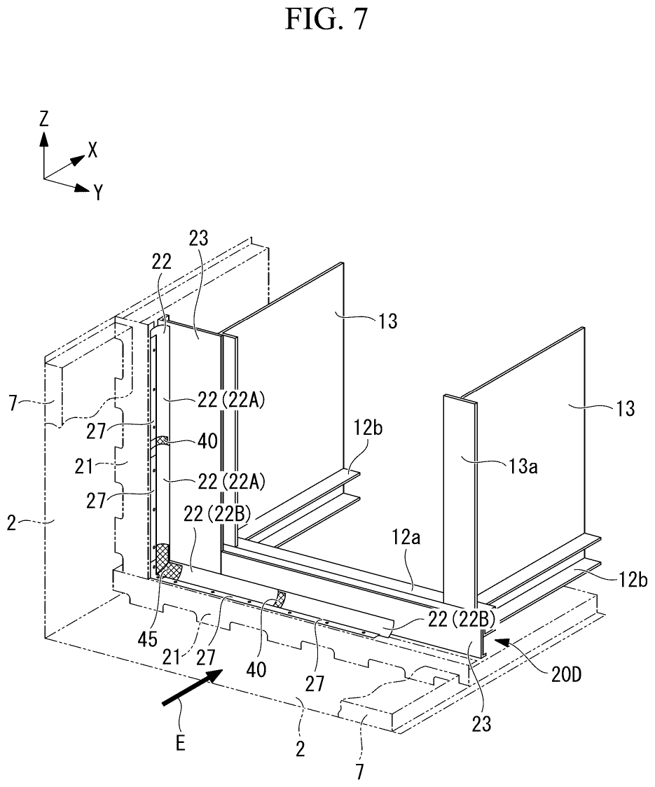

Next, a third embodiment of the present disclosure will be described with reference to FIG. 7. The present embodiment differs from the above second embodiment in that second catalyst parts (fourth catalyst seal parts) 45 are provided. In other respects, since the present modified example is substantially the same as the above second embodiment, the same features are labeled with the same references, and the detailed description thereof will be omitted. Note that, in FIG. 7, depiction of the first plate type catalyst 24 is omitted for purposes of illustration.

As illustrated in FIG. 7, a seal structure 20D according to the present embodiment has the second catalyst parts 45 each covering a gap formed between one end of a first sealing device 22A extending in the Z-axis direction and one end of the second sealing device 22B extending in the Y-axis direction. Each second catalyst part 45 has, in an integrated manner, a first portion covering the upstream face of the first sealing device 22A and a second portion covering the upstream face of the second sealing device 22B. The second catalyst part 45 is formed in a substantially L-shape.

The second catalyst part 45 is formed of a denitration catalyst. In detail, the second catalyst part 45 is cloth formed of heat-resistant fibers and entirely coated with denitration catalyst components. An example of the heat-resistant fiber may be a ceramic fiber or a glass fiber.

According to the present embodiment, the following effects and advantages are achieved.

The present embodiment includes the second catalyst part 45 covering a gap formed between one end of the first sealing device 22A and one end of the second sealing device 22B. Thus, the flue gas taking a short path via the gap formed between one end of a first sealing device 22A and one end of the second sealing device 22B is denitrated by being in contact with the second catalyst part 45. In such a way, since the flue gas taking a short path via the gap formed between one end of the first sealing device 22A and one end of the second sealing device 22B can be denitrated, the amount of an un-denitrated flue gas flowing through to downstream of the flue gas denitrizer 6 can be reduced.

Further, since the second catalyst part 45 covers a gap formed between one end of the first sealing device 22A and one end of the second sealing device 22B, this makes it difficult for the flue gas to pass through the gap formed between one end of the first sealing device 22A and one end of the second sealing device 22B. Therefore, since the amount of the flue gas taking a short path via the gap can be further reduced, the amount of an un-denitrated flue gas flowing through to downstream of the flue gas denitrizer 6 can be further reduced.

In the present embodiment, the second catalyst part 45 is cloth formed of heat-resistant fibers and entirely coated with denitration catalyst components. Accordingly, the second catalyst part 45 is more flexible compared to a case where the catalyst part is formed of a metal material, for example. Therefore, since the second catalyst part 45 can be easily deformed into a shape in accordance with the first sealing device 22A and the second sealing device 22B, the gap formed between one end of the first sealing device 22A and one end of the second sealing device 22B can be more suitably covered. Therefore, since the amount of the flue gas taking a short path via the gap can be further reduced, the amount of an un-denitrated flue gas flowing through to downstream of the flue gas denitrizer 6 can be further reduced.

Note that the present disclosure is not limited to the above embodiment, and modification can be made as appropriate within the scope not departing from the spirit thereof.

For example, Modified example 1 and Modified example 2 for the first embodiment described above may be combined with each other. Further, Modified example 1 and/or Modified example 2 for the first embodiment described above may be combined with the second embodiment and/or the third embodiment.

Further, gases to be subjected to denitration treatment are not limited to the flue gas discharged from a gas turbine and are applicable to gases discharged from boilers, engines, combustion furnaces, incinerators, and various reaction furnaces.

Further, although the example in which a flue gas denitrizer is provided in the duct 2 provided with the heat insulating materials 7 on the inner circumferential face (hereafter, referred to as “internal thermal insulation duct”) has been described in the above embodiments, the present disclosure is not limited thereto. For example, a flue gas denitrizer may be provided inside a duct provided with heat insulating materials on the outer circumferential face (hereafter, referred to as “external thermal insulation duct”). As described above, however, the seal structures described in the above embodiments can sufficiently absorb a thermal expansion difference between the seal member (the seal mounting bar 21 and the sealing device 22) fixed to the duct 2 and the seal member (the seal plate 23 and the first plate type catalyst 24) fixed to the flue gas denitrizer 6 and thus is more effective when applied to the internal thermal insulation duct having a large thermal expansion difference between the duct and the flue gas denitrizer than when applied to the external thermal insulation duct.

Further, although the example in which the flue gas denitrizer and the seal structure are provided inside a horizontal type duct in which a flue gas flows in the horizontal direction has been described in the above embodiment, the present disclosure is not limited thereto. For example, the flue gas denitrizer and the seal structure may be provided inside a vertical type duct in which a flue gas flows in the vertical direction. However, as described above, in the seal structures described in the above embodiments, the seal member (the seal mounting bar 21 and the sealing device 22) fixed to the duct 2 and the seal member (the seal plate 23 and the first plate type catalyst 24) fixed to the flue gas denitrizer 6 are not fixed to each other and are movable relative to each other. Thus, the seal structures described in the above embodiments are less likely to be damaged even when a displacement difference occurs over the entire circumference of the duct 2. Thus, the seal structures described in the above embodiments are effective even with the horizontal type duct in which a displacement difference is more likely to occur in the entire circumference of the duct 2 than in the vertical type duct.

The seal structure, the heat recovery steam generator, and the flue gas sealing method according to the embodiments described above are understood as follows, for example.

The seal structure according to one aspect of the present disclosure is a seal structure (20) configured to seal a gap formed between a duct (2) in which a flue gas flows through and a flue gas denitrizer (6) arranged in the duct (2), the seal structure includes: at least one duct-side seal part (22) fixed to the duct (2) and arranged in the gap; a flue gas denitrizer-side seal part (23) fixed to the flue gas denitrizer (6), arranged in the gap, and abutting against or being close to the duct-side seal part (22); and a first catalyst seal part (24) fixed to the flue gas denitrizer (6), arranged in the gap, and configured to push the duct-side seal part (22) against the flue gas denitrizer-side seal part (23), and the first catalyst seal part (24) is formed of a denitration catalyst.

Since a high-temperature flue gas flows through in the duct, the duct and the flue gas denitrizer are thermally expanded due to heat of the flue gas. At this time, for example, if the heat insulating material is provided to the inner wall face of the duct or the like, a thermal expansion difference may occur between the duct and the flue gas denitrizer.

In the above configuration, the duct-side seal part fixed to the duct side and the seal part (the flue gas denitrizer-side seal part and the first catalyst seal part) fixed to the flue gas denitrizer side are not fixed to each other. That is, the duct-side seal part and the flue gas denitrizer-side seal part seal the gap while being movable relative to each other. Thus, even when a thermal expansion difference occurs between the duct and the flue gas denitrizer, the duct-side seal part and the flue gas denitrizer-side seal part relatively move (slide and move), and this can absorb the thermal expansion difference.

Further, in the above configuration, the first catalyst seal part is arranged in the gap formed between the duct and the flue gas denitrizer. Thus, the flue gas taking a short path (that the flue gas flows through to downstream of the flue gas denitrizer without passing through the flue gas denitrizer) via the gap formed between the duct and the flue gas denitrizer is denitrated by being in contact with the first catalyst seal part. In such a way, since the flue gas taking a short path via the gap formed between the duct and the flue gas denitrizer can be denitrated, the amount of an un-denitrated flue gas flowing through to downstream of the flue gas denitrizer can be reduced.

Further, in the above configuration, the first catalyst seal part pushes the duct-side seal part against the flue gas denitrizer-side seal part. Thus, the gap formed between the duct-side seal part and the flue gas denitrizer-side seal part can be made small. Otherwise, formation of a gap between the duct-side seal part and the flue gas denitrizer-side seal part can be made difficult. Therefore, the amount of the flue gas taking a short path via the gap formed between the duct-side seal part and the flue gas denitrizer-side seal part can be reduced. Thus, the amount of an un-denitrated flue gas flowing through to downstream of the flue gas denitrizer can be reduced.

Further, in the seal structure according to one aspect of the present disclosure, the first catalyst seal part (24) is a plate-like metal member carrying a denitration catalyst component.

In the above configuration, the first catalyst seal part is a plate-like metal member. Accordingly, the first catalyst seal part is elastically deformed with relatively large stress. Therefore, the first catalyst seal part can strongly push the duct-side seal part against the flue gas denitrizer-side seal part. Thus, since the gap formed between the duct-side seal part and the flue gas denitrizer-side seal part can be made smaller, the amount of a flue gas taking a short path can be further reduced.

Note that an example of a metal used for the first catalyst seal part may be stainless steel.

Further, the seal structure according to one aspect of the present disclosure includes a second catalyst seal part (25) fixed to the flue gas denitrizer (6) and arranged between the duct-side seal part (22) and the flue gas denitrizer-side seal part (23), and the second catalyst seal part (25) is formed of a denitration catalyst.

The above configuration includes the second catalyst seal part arranged between the duct-side seal part and the flue gas denitrizer-side seal part. Further, the second catalyst seal part is formed of a denitration catalyst. Accordingly, the flue gas taking a short path via the gap formed between the duct-side seal part and the flue gas denitrizer-side seal part comes into contact with the second catalyst seal part and is thereby denitrated. In such a way, since the flue gas taking a short path via the gap formed between the duct-side seal part and the flue gas denitrizer-side seal part can be denitrated, the amount of an un-denitrated flue gas flowing through to downstream of the flue gas denitrizer can be reduced.

Further, since the second catalyst seal part is provided between the duct-side seal part and the flue gas denitrizer-side seal part, a pressure loss of a flue gas taking a short path via the gap formed between the duct-side seal part and the flue gas denitrizer-side seal part can be increased. This makes it difficult for the flue gas to pass through the gap. Therefore, since the amount of the flue gas taking a short path via the gap can be further reduced, the amount of an un-denitrated flue gas flowing through to downstream of the flue gas denitrizer can be further reduced.

Further, in the seal structure according to one aspect of the present disclosure, the first catalyst seal part (24) is inclined with respect to the flue gas denitrizer-side seal part (23) such that the distance to the duct-side seal part (22) increases as the distance to an abutment part abutting against the duct-side seal part (22) increases.

In the above configuration, the first catalyst seal part is inclined such that the distance to the duct-side seal part increases as the distance to the abutment part abutting against the duct-side seal part increases. This makes it possible to more strongly push the duct-side seal part against the flue gas denitrizer-side seal part by the first catalyst seal part. Thus, since the gap formed between the duct-side seal part and the flue gas denitrizer-side seal part can be made smaller, the amount of a flue gas taking a short path can be further reduced.

Further, in the seal structure according to one aspect of the present disclosure, a plurality of duct-side seal parts (22) are provided, the plurality of duct-side seal parts (22) are aligned along an intersecting direction that is a direction intersecting a flue gas flow, the duct-side seal parts (22) adjacent to each other are arranged such that ends of the duct-side seal parts overlap with each other, and a third catalyst seal part (40) formed of a denitration catalyst is provided between the ends overlapping with each other.

In the above configuration, the third catalyst seal part is provided between the ends of the duct-side seal parts overlapping with each other. Thus, the flue gas taking a short path via the gap formed between the ends of the duct-side seal parts overlapping with each other is denitrated by being in contact with the third catalyst seal part. In such a way, since the flue gas taking a short path via the gap formed between the ends of the duct-side seal parts overlapping with each other can be denitrated, the amount of an un-denitrated flue gas flowing through to downstream of the flue gas denitrizer can be reduced.

Further, since the third catalyst seal part is provided between the ends of the duct-side seal parts overlapping with each other, the third catalyst seal part can increase the pressure loss of the flue gas taking a short path via the gap formed between the ends of the duct-side seal parts overlapping with each other. This makes it difficult for the flue gas to pass through the gap. Therefore, since the amount of the flue gas taking a short path via the gap can be further reduced, the amount of an un-denitrated flue gas flowing through to downstream of the flue gas denitrizer can be further reduced.

Further, in the seal structure according to one aspect of the present disclosure, the third catalyst seal part (40) is cloth formed of heat-resistant fibers and carrying a denitration catalyst component.

In the above configuration, the third catalyst seal part is cloth formed of heat-resistant fibers and carrying a denitration catalyst component. Accordingly, the third catalyst seal part is more flexible compared to a case where the catalyst seal part is formed of a metal material, for example. Therefore, the third catalyst seal part is deformed into a shape in accordance with a gap formed between the ends of the duct-side seal parts overlapping with each other and thus can further fill the gap. This makes it more difficult for the flue gas to pass through the gap. Therefore, since the amount of the flue gas taking a short path via the gap can be further reduced, the amount of an un-denitrated flue gas flowing through to downstream of the flue gas denitrizer can be further reduced.

Further, in the seal structure according to one aspect of the present disclosure, a plurality of duct-side seal parts (22) are provided, the plurality of duct-side seal parts (22) have a first duct-side seal part (22A) extending in a first intersecting direction (the Z-axis direction) that is one of directions intersecting a flue gas flow and a second duct-side seal part (22B) extending in a second intersecting direction that is one of the directions intersecting the flue gas flow and is a direction intersecting the first intersecting direction (the Z-axis direction), the seal structure further includes a fourth catalyst seal part (45) covering a gap formed between one end of the first duct-side seal part (22A) and one end of the second duct-side seal part (22B), and the fourth catalyst seal part (45) is formed of a denitration catalyst.

The above configuration includes the fourth catalyst seal part covering a gap formed between one end of the first duct-side seal part and one end of the second duct-side seal part. Thus, the flue gas taking a short path via the gap formed between one end of the first duct-side seal part and one end of the second duct-side seal part is denitrated by being in contact with the fourth catalyst seal part. In such a way, since the flue gas taking a short path via the gap formed between one end of the first duct-side seal part and one end of the second duct-side seal part can be denitrated, the amount of an un-denitrated flue gas flowing through to downstream of the flue gas denitrizer can be reduced.

Further, since the fourth catalyst seal part covers a gap formed between one end of the first duct-side seal part and one end of the second duct-side seal part, this makes it difficult for the flue gas to pass through the gap formed between one end of the first duct-side seal part and one end of the second duct-side seal part. Therefore, since the amount of the flue gas taking a short path via the gap can be further reduced, the amount of an un-denitrated flue gas flowing through to downstream of the flue gas denitrizer can be further reduced.

Further, in the seal structure according to one aspect of the present disclosure, the fourth catalyst seal part (45) is cloth formed of heat-resistant fibers and carrying a denitration catalyst component.

In the above configuration, the fourth catalyst seal part is cloth formed of heat-resistant fibers and carrying a denitration catalyst component. Accordingly, the fourth catalyst seal part is more flexible compared to a case where the catalyst seal part is formed of a metal material, for example. Therefore, since the fourth catalyst seal part can be easily deformed into a shape in accordance with the first duct-side seal part and the second duct-side seal part, the gap formed between one end of the first duct-side seal part and one end of the second duct-side seal part can be more suitably covered. Therefore, since the amount of the flue gas taking a short path via the gap can be further reduced, the amount of an un-denitrated flue gas flowing through to downstream of the flue gas denitrizer can be further reduced.

The heat recovery steam generator according to one aspect of the present disclosure includes: a duct (2) in which a flue gas flows through; a heat exchange unit arranged in the duct (2) and configured to recover heat of a flue gas; a flue gas denitrizer (6) arranged in the duct (2); and the seal structure (20) according to any one of the above configured to seal a gap formed between the duct (2) and the flue gas denitrizer (6).

The flue gas sealing method according to one aspect of the present disclosure is a flue gas sealing method using a seal structure (20) configured to seal a gap formed between a duct (2) in which a flue gas flows through and a flue gas denitrizer (6) arranged in the duct (2), the seal structure (20) includes a duct-side seal part (22) fixed to the duct (2) and arranged in the gap, a flue gas denitrizer-side seal part (23) fixed to the flue gas denitrizer (6), arranged in the gap, and abutting against or being close to the duct-side seal part (22), and a first catalyst seal part (24) fixed to the flue gas denitrizer (6), arranged in the gap, and configured to push the duct-side seal part (22) against the flue gas denitrizer-side seal part (23), the first catalyst seal part (24) is formed of a denitration catalyst, and the flue gas sealing method includes: sealing a gap formed between the duct (2) and the flue gas denitrizer (6) by using the duct-side seal part (22), the flue gas denitrizer-side seal part (23), and the first catalyst seal part (24).

### REFERENCE SIGNS LIST

1 heat recovery steam generator
2 duct
3 duct inlet
4 duct outlet
5 heat exchange unit
6 flue gas denitrizer
7 heat insulating material
9 drum
11 catalyst pack
12 support frame
12a first support beam
12b second support beam
13 wall
13a flange part
20 seal structure
20A seal structure
20B seal structure
20C seal structure
20D seal structure
21 seal mounting bar
21a flange part
22 sealing device
22A first sealing device
22B second sealing device
22a fixing part
22b curved part
22c abutment part
23 seal plate
23a flange part
24 first plate type catalyst
25 second plate type catalyst
26 gasket
27 pressing metal fitting
28 fastener
31 pressing metal fitting
32 fastener
35 engagement part
40 first catalyst part
45 second catalyst part
G gap

1. A seal structure configured to seal a gap formed between a duct in which a flue gas flows through and a flue gas denitrizer arranged in the duct, the seal structure comprising:
at least one duct-side seal part fixed to the duct and arranged in the gap;
a flue gas denitrizer-side seal part fixed to the flue gas denitrizer, arranged in the gap, and abutting against or being close to the duct-side seal part; and
a first catalyst seal part fixed to the flue gas denitrizer, arranged in the gap, and configured to push the duct-side seal part against the flue gas denitrizer-side seal part,
wherein the first catalyst seal part is formed of a denitration catalyst.

2. The seal structure according to claim 1, wherein the first catalyst seal part is a plate-like metal member carrying a denitration catalyst component.

3. The seal structure according to claim 1 further comprising a second catalyst seal part fixed to the flue gas denitrizer and arranged between the duct-side seal part and the flue gas denitrizer-side seal part,
wherein the second catalyst seal part is formed of a denitration catalyst.

4. The seal structure according to claim 1, wherein the first catalyst seal part is inclined with respect to the flue gas denitrizer-side seal part such that the distance to the duct-side seal part increases as the distance to an abutment part abutting against the duct-side seal part increases.

5. The seal structure according to claim 1,
wherein a plurality of duct-side seal parts are provided,
wherein the plurality of duct-side seal parts are aligned along an intersecting direction that is a direction intersecting a flue gas flow,
wherein the duct-side seal parts adjacent to each other are arranged such that ends of the duct-side seal parts overlap with each other, and
wherein a third catalyst seal part formed of a denitration catalyst is provided between the ends overlapping with each other.

6. The seal structure according to claim 5, wherein the third catalyst seal part is cloth formed of heat-resistant fibers and carrying a denitration catalyst component.

7. The seal structure according to claim 1,
wherein a plurality of duct-side seal parts are provided,
wherein the plurality of duct-side seal parts have a first duct-side seal part extending in a first intersecting direction that is one of directions intersecting a flue gas flow and a second duct-side seal part extending in a second intersecting direction that is one of the directions intersecting the flue gas flow and is a direction intersecting the first intersecting direction,
the seal structure further comprising:
a fourth catalyst seal part covering a gap formed between one end of the first duct-side seal part and one end of the second duct-side seal part,
wherein the fourth catalyst seal part is formed of a denitration catalyst.

8. The seal structure according to claim 7, wherein the fourth catalyst seal part is cloth formed of heat-resistant fibers and carrying a denitration catalyst component.

9. A heat recovery steam generator comprising:
a duct in which a flue gas flows through;
a heat exchange unit arranged in the duct and configured to recover heat of a flue gas;
a flue gas denitrizer arranged in the duct; and
the seal structure according to claim 1 configured to seal a gap formed between the duct and the flue gas denitrizer.

10. A flue gas sealing method using a seal structure configured to seal a gap formed between a duct in which a flue gas flows through and a flue gas denitrizer arranged in the duct,
wherein the seal structure comprises
a duct-side seal part fixed to the duct and arranged in the gap,
a flue gas denitrizer-side seal part fixed to the flue gas denitrizer, arranged in the gap, and abutting against or being close to the duct-side seal part, and
a first catalyst seal part fixed to the flue gas denitrizer, arranged in the gap, and configured to push the duct-side seal part against the flue gas denitrizer-side seal part,
wherein the first catalyst seal part is formed of a denitration catalyst,
the flue gas sealing method comprising:
sealing a gap formed between the duct and the flue gas denitrizer by using the duct-side seal part, the flue gas denitrizer-side seal part, and the first catalyst seal part.
